(19) United States
(12) Patent Application Publication
(10) Pub. No.: US 2024/0186782 A1
(43) Pub. Date: Jun. 6, 2024

(54) CLAMP FOR SUSPENDING WIRE

(71) Applicant: PREFORMED LINE PRODUCTS CO., Mayfield Village, OH (US)

(72) Inventors: Derek Alexander LENARDOS, Akron, OH (US); Cameron Joseph CLINES, Chagrin Falls, OH (US); Benjamin Franklin CIESIELCZYK, Madison, OH (US); Jacob Jeffrey PALMER, Chesterland, OH (US)

(21) Appl. No.: 18/074,680

(22) Filed: Dec. 5, 2022

(51) Int. Cl. H02G 7/05; H02G 1/04

(52) U.S. Cl. CPC H02G 7/053; H02G 1/04

(57) ABSTRACT

A clamp for suspending a wire is provided. The clamp includes a base having a support surface that defines a first boundary of a wire receiving region. The clamp includes a keeper having an elastomer lining that defines a second boundary of the wire receiving region. The clamp includes means for providing force to at least one of the keeper or the base such that, when the wire is in the receiving region, the elastomer lining is pressed against the wire to provide a static retaining force, as a function of the force, on the wire to retain the wire relative to the clamp and permits sliding of the wire relative to the clamp when a pulling force on the wire exceeds the static retaining force and remains within a designed slip force range.

### TECHNICAL FIELD

The subject disclosure is generally directed towards a support structure. For example, the subject disclosure is directed towards a clamp of a support structure for supporting a wire, such as an electrically conductive cable as an example.

### BACKGROUND

A support structure that includes a clamp may be used for supporting a wire, such as an electrically conductive cable or the like. The wire may be at least partially surrounded by the support structure.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

In an example, the present disclosure provides a clamp for suspending a wire. The clamp includes a base having a support surface that defines a first boundary of a wire receiving region. The clamp includes a keeper having an elastomer lining that defines a second boundary of the wire receiving region. The clamp includes means for providing force to at least one of the keeper or the base such that, when the wire is in the receiving region, the elastomer lining is pressed against the wire to provide a static retaining force, as a function of the force, on the wire to retain the wire relative to the clamp and permits sliding of the wire relative to the clamp when a pulling force on the wire exceeds the static retaining force and remains within a designed slip force range.

In an example, the present disclosure provides a method of suspending a wire with permitted slip or slide of the wire (e.g., slip, slipping, slide, sliding, etc. may be used interchangeably herein). The method includes providing a clamp. The clamp includes a base comprising a support surface that defines a first boundary of a wire receiving region. The clamp includes a keeper comprising an elastomer lining that defines a second boundary of the wire receiving region. The clamp includes operable means for providing force to at least one of the keeper or the base. The method includes placing the wire into the wire receiving region, operating the means for providing force such that the elastomer lining is pressed against the wire to provide a static retaining force on the wire to retain the wire relative to the clamp, and upon occurrence of a pulling force on the wire exceeding the static retaining force and remaining within a designed slip force range, permitting sliding of the wire relative to the clamp.

In an example, the present disclosure provides an elastomer lining for a keeper of a clamp. The elastomer lining has a concave surface that defines a first boundary of a wire receiving region within which a wire that is suspended by the clamp is received. The elastomer lining has a structure that provides a retaining force relative to a body of the keeper such that the elastomer lining is retained relative to the body, wherein the retaining force is greater than a pulling force exerted on the wire that induces sliding of the wire relative to the clamp when the wire is suspended by the clamp.

The following description and annexed drawings set forth certain illustrative aspects and implementations. These are indicative of but a few of the various ways in which one or more aspects may be employed. Other aspects, advantages, and/or novel features of the disclosure will become apparent from the following detailed description when considered in conjunction with the annexed drawings.

### DESCRIPTION OF THE DRAWINGS

FIG. 1 is a perspective, schematic illustration of an example tower for supporting example wires elevated above ground, and upon which one or more support structures, which structures may each include a clamp in accordance with one or more aspects of the present disclosure, may be utilized for supporting one or more wires.

FIG. 2 is a perspective view illustration of an example clamp in accordance with one or more aspects of the present disclosure.

FIG. 3 is a side view illustration of the example clamp of FIG. 2.

FIG. 4 is an end view illustration of the example clamp of FIG. 2.

FIG. 5 is an exploded perspective illustration of the example clamp of FIG. 2.

FIG. 6 is a perspective illustration of an example keeper of the example clamp of FIG. 2.

FIG. 7 is a side view illustration of the example keeper of FIG. 6.

FIG. 8 is an end view illustration of the example keeper of FIG. 6.

FIG. 9 is top view illustration of the example keeper of FIG. 6.

FIG. 10 is bottom view illustration of the example keeper of FIG. 6.

FIG. 11 is an exploded perspective illustration of the example keeper of FIG. 6.

FIG. 12 is another exploded perspective illustration of the example keeper of FIG. 6.

FIG. 13 is a graph showing an example plot of sliding force associated with sliding length, and shows authorized zones and restricted zones for the plot.

FIG. 14 is a view similar to FIG. 7, but for another example keeper.

FIG. 15 is a side view of an example liner of the keeper shown within FIG. 14.

FIG. 16 is an end view of the liner of FIG. 15.

FIG. 17 is a section view of the keeper of FIG. 14.

FIG. 18 is a section view of the liner of FIG. 15, with the section being taken along line 18-18 in FIG. 16.

FIG. 19 is a section view of the liner of FIG. 15, with the section being taken along line 19-19 in FIG. 15.

FIG. 20 is a side view of an example stiffener of the liner shown within FIG. 18.

FIG. 21 is a perspective view of the stiffener of FIG. 20.

FIG. 22 is a top-level flow chart for an example method to suspend a wire with permitted slip of the wire in accordance with an aspect of the present disclosure.

### DETAILED DESCRIPTION

The claimed subject matter is now described with reference to the drawings, wherein like reference numerals are used to refer to like elements throughout. In the following description, for purposes of explanation, numerous specific details are set forth in order to provide an understanding of the claimed subject matter. It is evident, however, that the claimed subject matter may be practiced without these specific details. In other instances, structures and devices are illustrated in block diagram form in order to facilitate describing the claimed subject matter. Relative size, orientation, etc. of parts, components, etc. may differ from that which is illustrated while not falling outside of the scope of the claimed subject matter.

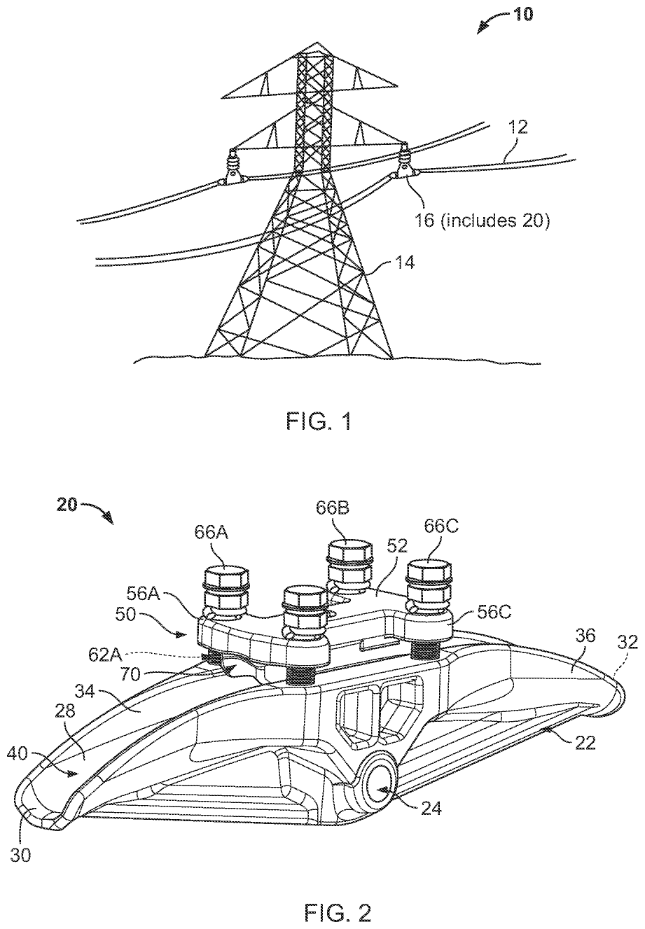

Turning to FIG. 1, an example use environment 10 is schematically shown. The shown example is an overhead power line environment 10. Of course, such is just an example and it is to be understood that other variations/examples are contemplated and within the scope of the present disclosure.

The overhead power line environment 10 comprises any number of structures, configurations, constructions, etc. In an example, the overhead power line environment 10 may be used in association with electric power transmission and/or distribution. Within the example, one or more wires 12, which are electrically conductive, may be suspended by a tower, pole, or the like, which is schematically represented within FIG. 1 via reference numeral 14. It is to be appreciated that the towers, poles, or the like 14 may be varied. The example shown within FIG. 1 is only an example. The variation of the towers, poles, or the like 14 is contemplated and within the scope of the present disclosure. Herein, for simplicity, the tower, pole, or the like is referred to simply as the tower 14, but with an understanding that variation and broad interpretation are present.

It is to be appreciated that electric power transmission and/or distribution, and the wire(s) 12 therefor is just one example. It is contemplated that the wire(s) 12 may be for other function(s), such as communications, other transmissions, etc. So, for the purposes of the present disclosure, the term “wire” is to be broadly interpreted and may include, but is not limited to, line, cable, mono-filament wire, stranded wire, multiple/bundled cables or wires, fiber optic line line(s), overhead shielded wire, conductors, optical ground wire (OPGW), and all-dielectric self-supporting fiber optic cable (ADSS). Thus, it is to be appreciated that the wire(s) 12 may be varied and such variation is contemplated and within the scope of the present disclosure. In some examples, the wire(s) 12 is an electrically conductive wire or cable that may transmit electrical energy through the wire(s) 12. The wire(s) 12 may comprise a metal material that is electrically conductive. The wire(s) 12 may extend between plural towers, poles, or the like and, in the illustrated example, may be supported at a distance above the ground (e.g., overhead). Herein, for simplicity, the wire(s) 12 is referred to simply as the wire 12, but with an understanding that variation and broad interpretation are present.

The overhead power line environment 10 includes at least one support 16 for suspending the wire 12 from the tower 14. It will be appreciated that the example of FIG. 1 schematically illustrates the support 16. It is to be appreciated that the support 16 is not limited to the illustrated size, shape, construction, design, etc. Rather, the support 16 may be of any number of constructions, some of which may be used to support a structure (e.g., the wire 12, etc.) at a distance above the ground or the like. The support 16 may be directly or indirectly attached to the tower 14.

Within an example in accordance with an aspect of the present disclosure, the support 16 includes a clamp 20 that is in accordance with an aspect of the present disclosure.

Referring to FIG. 2, a perspective view of an example clamp 20 that is in accordance with an aspect of the present disclosure is shown. The clamp 20 is for supporting the wire 12 (see for example FIG. 1). As such, the clamp 20 may support (e.g., hold, grip, etc.) the wire 12 and maintain a tension in the wire without damaging the wire 12. Examples of such avoidance of damage include not damaging a sheath or outer covering of the wire, if the wire includes such. The support 16 may include various other structures, configurations, etc. to interface, engage, hold, support, etc. the clamp 20 relative to the tower 14. Such variation of the support 16 is contemplated and within the scope of the present disclosure. With the clamp 20 supporting the wire 12 and the support 16 interfacing, engaging, holding, supporting, etc. the clamp 20 relative to the tower 14, the wire may be supported above a surface such as the ground, roads or other objects. An example of such is shown via FIG. 1.

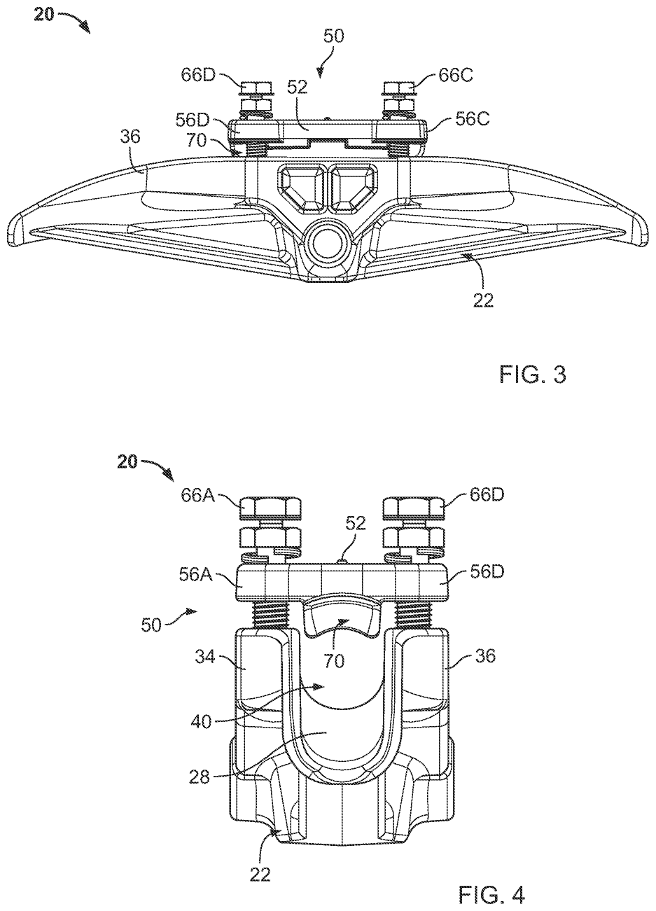

The example clamp 20 (see FIGS. 2-5) includes a base 22. The base 22 is attached, interfaces or the like within the overall support 16. The specifics of the attachment, interface, etc. between the base 22 and the remainder of the overall support 16 may be varied and such variation is contemplated and within the scope of the present disclosure. Within the shown example, the base 22 includes a through-hole 24 for receiving a bolt, pin or similar, with such bolt/pin providing at least part of an example attachment/interface between the base and the remainder of the overall support 16. Again, it is to be appreciated that such an example may be varied and that such variation is within the scope of the present disclosure.

The base 22 has an inner support surface 28. The wire 12 rests upon the inner support surface 28. The inner support surface 28 may be shaped, configured, contoured or the like to complement the size (e.g., cross-sectional diameter) and/or cross-sectional shape of the wire 12. The inner support surface 28 may be curved (e.g., have a radius) along an extent parallel to a longitudinal extend of the wire 12. Also, the inner support surface 28 may have curved or arc-shaped, tapered longitudinal end portions 30, 32. Still further, the inner support surface may have a lateral (i.e., side-to-side, perpendicular to the longitudinal extend of the wire 12) curvature. Still further, the base may have two generally vertical walls 34, 36. Each vertical, side wall 34, 36 is located at one of the respective lateral sides of the base 22. Each vertical wall 34, 36 rises from the inner support surface 28.

The inner support surface 28 and the vertical walls 34, 36 define a wire receiving region 40. The inner support surface 28 may define a bottom, as viewed within FIG. 2, of the wire receiving region 40, and the vertical walls 34, 36 may define sides of a wire receiving region 40. In general, the wire receiving region 40 provides support and may help alleviate a possibility of damage to the wire.

The clamp 20 further includes a keeper 50. The keeper 50 provides a movable upper surface or boundary of the wire receiving region 40. In the example, the wire 12 (e.g., see FIG. 1) is disposed between the inner support surface 28 and the keeper 50 when the wire 12 is suspended by the clamp 20.

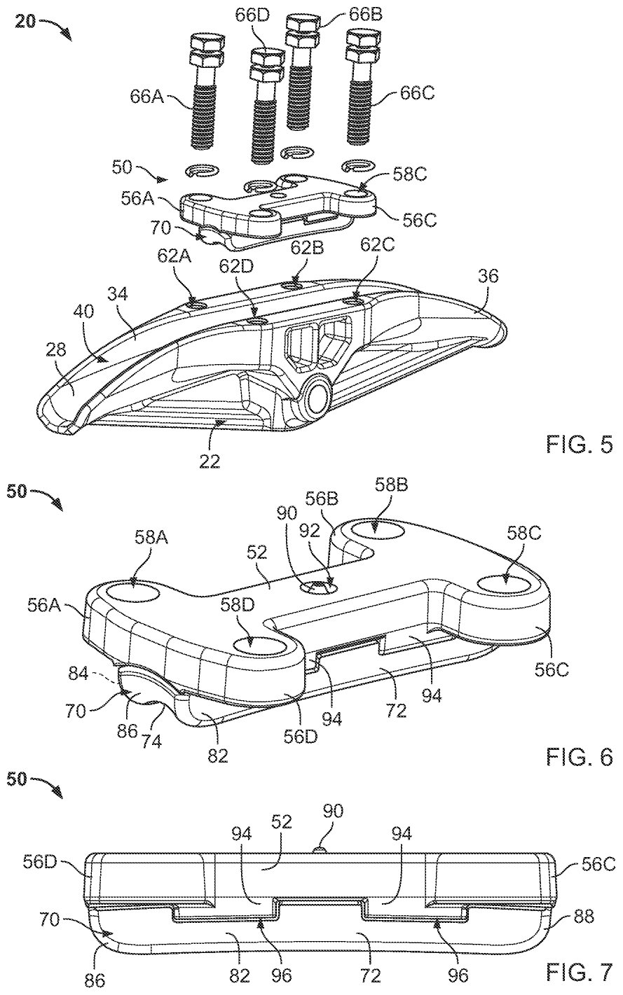

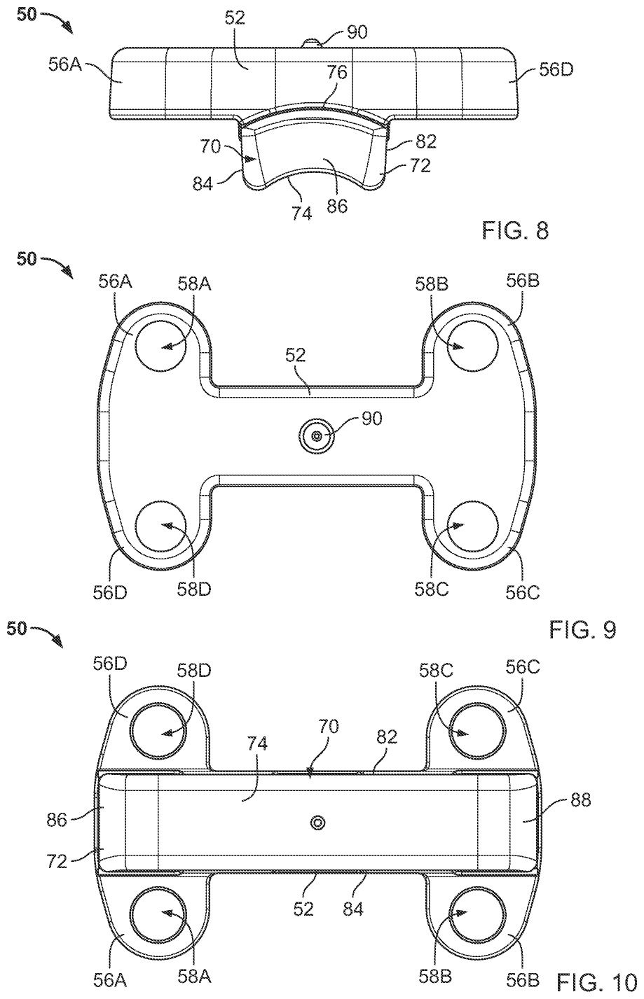

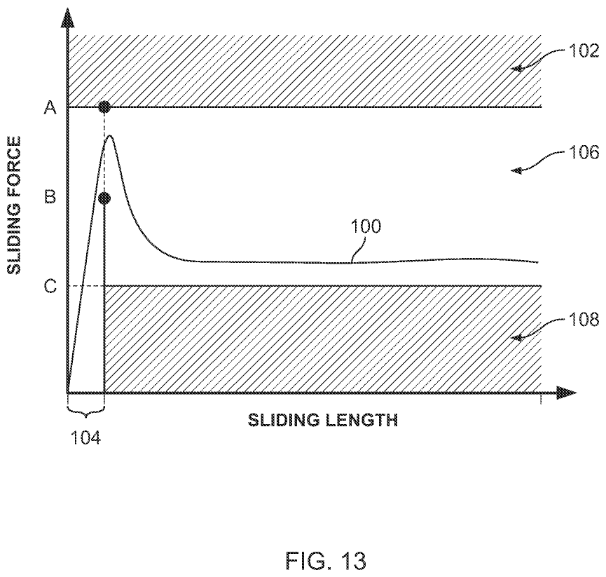

The shown example keeper 50 (see FIGS. 6-12) includes a body 52 and four arms 56A-56D. The body 52 is generally situated over the wire receiving region 40 (see FIGS. 2-5). The arms 56A-56D extend out, over the vertical walls 34, 36 of the base 22. Each arm 56A-56D has a respective through-hole 58A-58D (see FIGS. 6-12) and an associated portion of the base includes a threaded bore 62A-62D (FIG. 5). Threaded fasteners (e.g., four bolts) 66A-66D, are provided to extend respectively through the through-holes 58A-58D in the arms 56A-56D and respectively into the threaded bores 62A-62D.

It is to be appreciated that fasteners 66A-66D may have a variety of constructions/configurations and that such variety is within the scope of the present disclosure. The fasteners 66A-66D are constructed/configured such that operation (e.g., tightening) of the fasteners 66A-66D may move the keeper 50 relatively toward the base 22. More specifically, the body 52 of the keeper 50 is moved toward the inner support surface 28 of the base 22. The volume/cross-sectional area between the keeper 50 and the inner support surface 28 is reduced. With the wire 12 within the wire receiving region 40, the wire may be pressed between the keeper 50 and the inner support surface 28. In other words, pressing force is applied to the wire 12. The force provides a retention or “keeping” force to the wire 12 such that the clamp 20 holds the wire 12 relative to the tower 14.

As such, one or more of the fasteners 66A-66D provide(s) an example of a portion(s) or means for providing force (e.g., pressing of “keeping” force) such that the wire 12 is pressed between the keeper 50 and the base 22. It is to be appreciated that different examples of constructions, configuration and the like of portion(s) or means for providing force are contemplated and within the scope of the present disclosure. Such examples include various threaded fasteners, camming structure and the like. Accordingly, means for providing force is to be broadly interpreted and not to be limited by the examples presented herein.

It is to be appreciated that, although one purpose of the clamp 20 is to hold the wire 12 relative to the tower 14 as mentioned above, there may be some circumstances for which movement of the wire relative to the clamp and thus the tower is desired. Specifically, there may be circumstance for which movement of the wire 12 in the longitudinal direction of the wire 12 relative to the clamp 20 and the tower 14 may be desired. Such longitudinal movement of the wire 12 may be referred to as slip. Some example circumstances for which slip is desired may include force(s) that are applied to the wire 12 that may result in undesired pulling forces being transmitted to the tower 14 and/or forces that may risk damage (e.g., breaking) of the wire, damage to the tower 14, etc.

As set forth by the present disclosure, there needs to be a level of precision such that the retention or “keeping” force (e.g., physical resistance against slip movement of the wire 12) provided by the clamp 20 is present when there is not a circumstance for which slip would be desired and yet slip is permitted when there is a circumstance for which slip would be desired. Such is an aspect in accord with the present disclosure. Moreover, such may be referred to as controlled slip.

An example of the aspect that is in accord with the present disclosure is shown with the Figures. Specifically, the shown example includes an elastomer lining 70 on the keeper 50 of the suspension clamp assembly 20 that interfaces with the wire 12. As such, the elastomer lining 70 abuts the wire 12. Also, the elastomer lining 70 is the portion of the keeper 50 that abuts the wire 12. The elastomer lining 70 may provide an amount of friction.

The elastomer lining 70 is located beneath the body 52 of the keeper 50 and faces into the wire receiving region 40. With the fasteners 66A-66D secured in a tightened condition, the body 52 of the keeper 50 holds the elastomer lining 70 relatively downwardly, as viewed within FIG. 2, and between the vertical walls 34, 36. Moreover, the elastomer lining 70, with the fasteners 66A-66D secured in a tightened condition, exerts a pressing force upon the wire 12 that is located within the wire receiving region 40. It is to be noted that the elastomer lining 70 abuts against the body 52 of the keeper 50. The pressing force is via pressing between the inner support surface 28 and the elastomer lining 70. Such pressing force provide a retaining force such that the wire is held against longitudinal movement (i.e., help against slip via the “keeping” force). However, at some desired level of pulling force, the wire 12 will move (i.e., slip) relative to the keeper 50. Within the example, the movement (i.e., slip) is relative to the elastomer lining 70. In accordance with an aspect of the present disclosure, the presence of the elastomer lining 70 helps provide for the movement at the desired level of pulling force. Within some examples, one or more of: a material of the elastomer lining 70, a resilience (i.e., elastic deformability) of the elastomer lining, a shape/contour of the elastomer lining, etc. helps provide for the movement at the desired level of pulling force. So, the clamping force provided by the clamp 20 to the wire, 12, in combination with the elastomer lining 70, provide friction to resist movement of the wire 12.

The show example elastomer lining 70 is but an example and it is to be appreciated that other example elastomer linings are possible, contemplated and within the scope of the present disclosure.

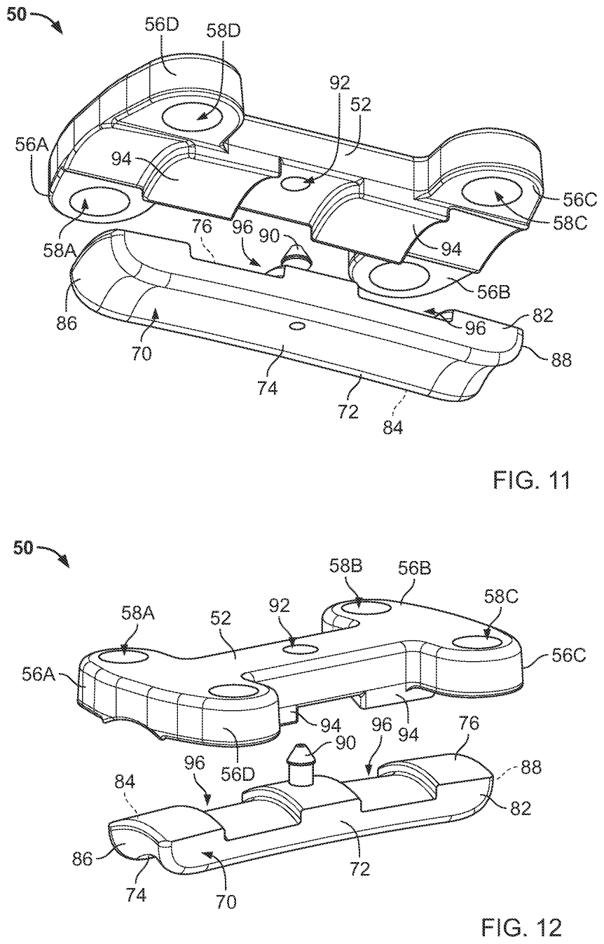

Focusing upon the show example elastomer lining 70 (see FIGS. 6-12), the elastomer lining includes a body 72. The body 72 has a downwardly (as viewed within FIG. 11) facing surface 74, an upwardly (viewed within FIG. 11) facing surface 76. The body 72 also has two lateral side surfaces 82, 84 and two longitudinal ends 86, 88.

Further within the shown example of the body 72, the downwardly facing surface 74 is concave in a lateral (i.e., side to side) direction. As such the body 72 extends into the wire receiving region 40 to a greater amount adjacent to the lateral side surfaces 82, 84. Such concavity thus may generally follow a cylindrical convexity of the wire 12 that is located the wire receiving region 40 and engaged by the body 72.

The elastomer lining 70 may include one or more structures/features to retain the elastomer lining relative to the body 52 of the keeper 50. Within the shown example, the elastomer lining 70 may include a protrusion 90 (e.g., a nipple) that protrudes from the upwardly facing surface 76. The body 52 may include an aperture 92 that receives the protrusion 90. The protrusion 90 and the aperture 92 may be constructed and configures such that the protrusion 90 is retained within the aperture 92 (e.g., there is an inter-fitting). As an example, the protrusion 90 may include an enlarged head that has a diameter that is greater than a diameter of the aperture 92. As such, the protrusion 90 and the aperture 92 may provide for retention of the protrusion 90 within the aperture 92 via interference fitting.

Also within the shown example, the body 52 and the elastomer lining 70 may have other inter-fitting portions that may help prevent relative movement. As shown, the body 52 includes protruding blocks 94 that extend downwardly, as shown within FIG. 11. The elastomer lining 70 includes mating recesses 96 located at the upwardly facing surface 76 into which the protruding blocks 94 fit. The amount/size of such inter-fitting may be varied. One example of such inter-fitting includes a height at the block/recess interface of approximately 4 mm. Of course, different heights (i.e., different, greater or smaller, than approximately 4 mm) is contemplated and within the scope of the present disclosure.

Also within the shown example within the figures, there are two protruding blocks 94 and two mating recesses 96. A different number (e.g., one, or three or more) of blocks and associated recesses are contemplated and within the scope of the present disclosure. Further, the show example within the figures presents that the blocks have a general square shape. Different shapes (e.g., rectangular) are contemplated and within the scope of the present disclosure. Also, within a plurality of blocks and associated recesses, relatively different sizes, shapes, placements, etc. are contemplated and within the scope of the present disclosure. For example, any one or more of the elements, features, etc. shown, described, etc. herein could be flipped, placed in a reverse position, etc. For example, a protrusion could be from the body and a corresponding aperture could be in the elastomer lining, a block could protrude from the elastomer lining and a corresponding recess could be in the body, etc.

In general, for various aspects/structures, variations are contemplated and within the scope of the present disclosure.

As mentioned, the elastomer lining 70 may help provide a resistance against slip movement of the wire 12 and the elastomer lining 70 may have any of one or more characteristics, attributes or the like to provide such. Examples of characteristics, attributes or the like include specific material(s) of the elastomer lining 70, surface texturing of the elastomer lining 70, variation of hardness of the elastomer lining 70. Also, tightness or torque of the fasteners 66A-66D could be varied and the like.

As some further examples of characteristics, attributes or the like of the elastomer lining 70, please note that following are possible examples. For example, the material may include ethylene propylene diene monomer rubber (EPDM), fluoroelastomers (FKM), urethane, silicone (including silicone compounds) or similar. The EPDM, FKM or similar may be semi-conductive. Within an example that includes EPDM, the EPDM may have a hardness range of 76-82 Shore A. Within an example that includes FKM, the FKM may have a hardness range of 70-80 Shore A. Within an example that includes urethane, the urethane may have a hardness up to a hardness of 60 Shore D. Of course, it is to be appreciated that the above-mentioned examples are not specific limitations upon the present disclosure and that other examples, and specifics therefor, are contemplated and within the scope of the present disclosure. Also, various combinations of materials are contemplated and within the scope of the present disclosure.

Again in general, variations are contemplated and within the scope of the present disclosure.

It is to be appreciated that other structures and the like may be provide to aid within the controlled slip. For example, a lubricant may be applied within the wire receiving region 40. Within an example, the lubricant may be a molybdenum-based lubricant. Within another example, the lubricant may be a dry lubricant.

It is to be appreciated that slip occurrence is based upon receipt of a specified pulling force (e.g., pressure) upon the wire 12. Moreover, the start of slip is based upon a starting (e.g., initial) force. Such may be based in part upon static friction force. It is to be appreciated that kinetic or sliding friction (i.e., friction that is present once relative movement is occurring) may be less than static friction. As such, it is possible that a lesser pulling force may be needed for continued sliding movement once the starting (e.g., initial) force causes the movement to begin. The static friction and the kinetic friction resist movement of the wire 12 in effort to retain the wire in place, and static friction and the kinetic friction may be referred to as providing a static retaining force and a kinetic retaining force, respectively. The static retaining force is a force level at which a non-moving wire 12 begins to move due to the pulling force upon the wire exceeding that force level. The kinetic retaining force is a force level at which a moving wire 12 will cease to move due pulling force upon the wire decreasing below that force level. It is to be appreciated that the kinetic retaining force is generally less than the static retaining force. For example, it generally takes more force to start the wire sliding (e.g., overcome the static retaining force) than to keep the wire sliding (e.g., overcome the kinetic retaining force). However, it is possible that galling, shearing, melting, etc. can occur from/during wire movement such that the force required to keep the wire moving, sliding, etc. (e.g., overcome the kinetic retaining force) increases to a level that exceeds the force required to start the wire moving, sliding, etc. (e.g., overcome the static retaining force). Sliding of the wire relative to the clamp can be said to occur when a pulling force on the wire exceeds the static retaining force and remains within a designed slip force range, where the designed slip force range generally comprises forces sufficient to overcome the kinetic retaining force imposed by kinetic friction. Note that in situations where the force required to keep the wire moving, sliding, etc. increases to a level that exceeds the force required to start the wire moving, sliding, etc. (e.g., due to galling, shearing, melting, etc. that can occur from/during wire movement), the designed slip force range may also (e.g., inherently or by definition) comprise forces sufficient to overcome the static retaining force imposed by static friction.

Moreover, in accordance with an aspect of the present disclosure, the clamp 20 may be configured such that the amount of force required to continuously pull, via slippage, of the wire 12 through the clamp may be within a range of a certain minimum and maximum force (i.e., a bounded range or designated slip force range). Within an example, the clamp 20 may be configured to keep the force required to continuously slip the wire 12 through the clamp relatively constant (e.g., within a range) over a pre-defined/desired distance. Within an example, such distance may be one meter. Within an example, it could take approximately 1000 lb of force to begin wire 12 slippage, then during continued pulling of one meter of wire through the clamp 20, the force required to maintain this continuous slip would stay within a range of approximately 500-700 lb (i.e., not go above or below these values). Of course, a bounded range of approximately 500-700 lb is just an example. Other different ranges are contemplated and within the scope of the present disclosure. A range may be selected based upon various factors, including specifics of the wire 12, the length of the span of the wire, associated structures, associated environment, etc. To be clear, various factors may be utilized and the range may be adjusted accordingly. Such range or window of force for slippage is unique. The bounded range is above the kinetic retaining force. Thus, it is to be appreciated that the present disclosure provides the aspect of an initial pulling force, above the static retaining force, on the wire is required to begin wire slippage and pulling force on the wire within a range that is above the kinetic retaining force, and remaining within the bounded range (e.g., designed slip force range), is required during continued slippage over a distance.

FIG. 13 is a graph showing an example plot 100 of sliding force associated with sliding length, and shows authorized zones and restricted zones for the plot. As can be appreciated from FIG. 13, a force amount “A” denoted a force level that is not to be exceeded and thus a lower level of a first or upper restricted zone 102. A first or initial authorized zone 104 extend from zero to the force amount “A.” Within such first authorized zone 104, the force applied to the wire 12 is in an initial state and causes initial slipping. Such involves overcoming static friction. However, once the static friction is overcome and the wire is slipping, the force decreases, due in part because of the occurrence of slippage.

While the slippage continues to occur, the force will be within a bounded range “B” and within a second authorized zone 106. A lower limit of the second authorized zone 106 is at a force amount of “C.” The bounded range is above the kinetic retaining force. Once the force falls below the force amount of “C,” a second restricted zone 108 indicates that further slippage is to cease.

So, in general, the base, the keeper and the means for providing force are configured such that an initial pulling force on the wire is required to begin wire slippage and pulling force on the wire within a range is required during continued slippage over a distance.

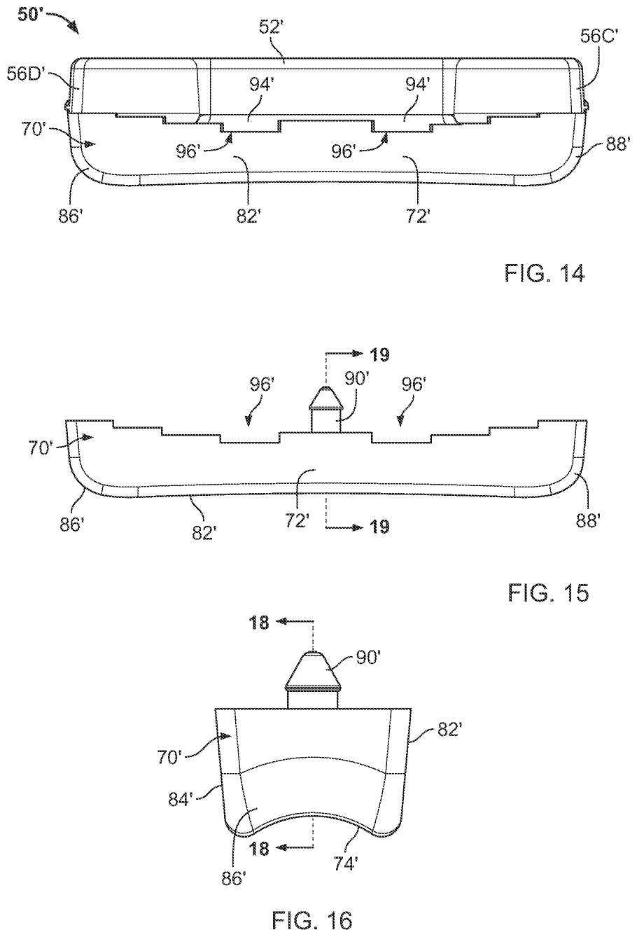

It is to be appreciated that the present disclosure is to be broadly interpreted as to the construction/configuration/etc. of the portions (e.g., the keeper may have a different construction/configuration/etc.). An example of a keeper 50′ that has such an example of a different construction/configuration/etc. is shown within FIG. 14. It is to be appreciated that the keeper 50′ has some similarities/similar portions as the keeper 50 described above. As such, some of the same reference numerals are utilized to describe portions of the keeper 50′, but with a “′” (prime) added. It is to be appreciated that descriptions provided above may be generally applicable to the keeper 50′.

As an example of a difference, note that the protruding blocks 94′ on the body 52′ each have a multiple level or stairstep configuration. The mating recesses 96′ on the lining 70′ have a complementary multiple level or stairstep configuration. See FIG. 15. Of course, some portions of the keeper 50′ may be the same or similar to as described above for the keeper 50. For example, the ends 86′, 88′ (see FIGS. 15 and 16) may be the same/similar and the facing surface 74′ may be the same/similar.

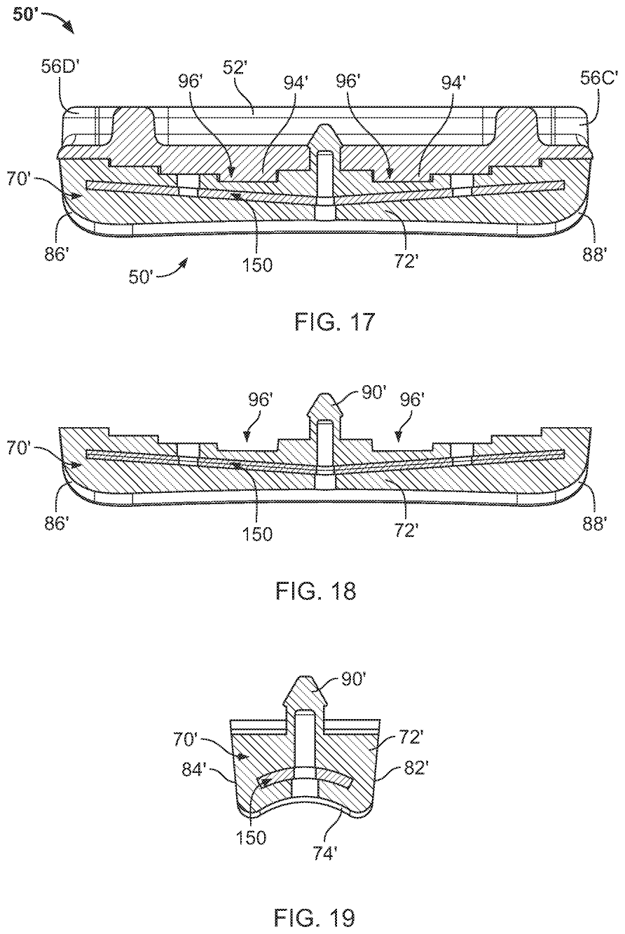

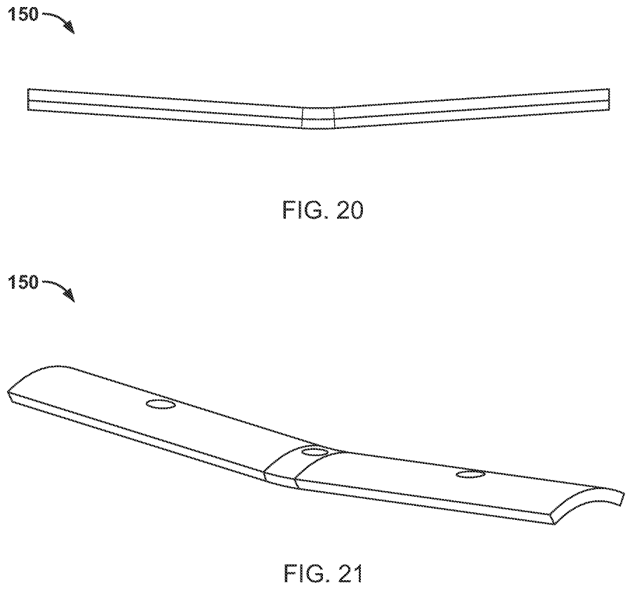

Again, returning to the topic that the present disclosure is to be broadly interpreted regarding modification/variation, it is to be appreciated that the lining 70′ may have further modifications, differences, etc. An example of such is shown within FIGS. 17-21. Specifically, FIGS. 17-19 are section views to show an embedded stiffener or lug 150 that is encapsulated within an outer material (e.g., elastomer). FIGS. 20 and 21 show the stiffener 150 by itself.

It is to be appreciated that the stiffener 150 may have any of a variety of shapes and sizes. Within the shown example, the stiffener 150 has a general “V” shape along its major extent (i.e., extending from ends 86′, 88′). See FIGS. 17, 18, 20 and 21. Also, the stiffener 150 may have a concavity, e.g., downwardly facing), when viewed from an end. See FIG. 19. Such concavity may mimic the concavity of the downwardly facing surface 74′. The stiffener 150 may include apertures, other contouring, etc. Such may help to provide for bonding to the encapsulating material (e.g., the elastomer/rubber).

It is to be appreciated that the stiffener 150 may be made of a variety of materials and may have a variety of dimensions, etc. Within an example, the stiffener 150 is made of aluminum. Of course, other materials and other materials are contemplated and within the scope of the present disclosure. For the example of the stiffener 150 being aluminum, the aluminum may be of 3003 grade aluminum sheet or 5052 aluminum grade sheet as some examples. Also, the stiffener 150 may have a thickness of approximately 0.090 inches (approximately 2.3 mm). But, of course, thickness variation is are contemplated and within the scope of the present disclosure. An example, of an approximate ratio of elastomer/rubber to aluminum at central cross section is about 5.7:1. Here also, variation is contemplated and within the scope of the present disclosure.

It is to be appreciated that associated methods are provided by the present disclosure. For example, a method of providing (e.g., constructing) the clamp 20 is to be appreciated as being within the scope of the present disclosure. Another example method provided by the present disclosure is a method of suspending a wire with permitted slip of the wire. Such method of suspending a wire may include a method of providing the clamp 20.

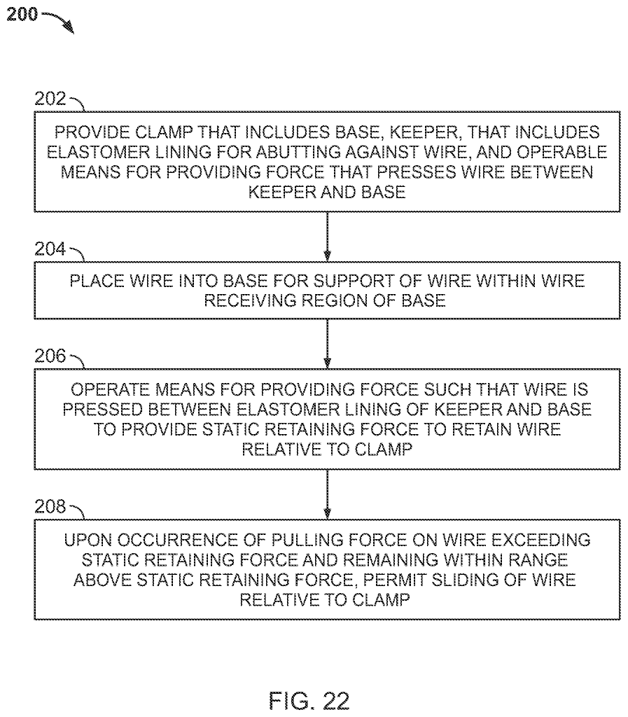

Turning to an example of a method of suspending a wire with permitted slip of the wire, attention is directed to FIG. 22 which shows a top-level flow chart of such an example method 200. It is to be appreciated that the method may be varied and that additional/sub-actions, operations, etc. may be provided. Such variation is within the scope of the present disclosure.

The example method 200 is for suspending a wire with permitted slip of the wire. At 202 a clamp is provided. The clamp may include a base that includes a support surface that partially defines a wire receiving region. The base is to support the wire within the wire receiving region. The clamp may include a keeper that defines an upper boundary of the wire receiving region. The keeper includes an elastomer lining abutting against the wire. The clamp may include operable portion(s) or means (e.g., bolts or similar) for providing force that presses the wire between the keeper and the base.

At 204 the wire is placed into the base for support of the wire within the wire receiving region of the base. At 206 the means for providing force is operated such that the wire is pressed between the elastomer lining of the keeper and the base to provide a static retaining force to retain the wire relative to the clamp. At 208, upon occurrence of a pulling force on the wire exceeding the static retaining force, the wire is permitted to slide relative to the clamp.

Of course, different and/or additional sub-actions, operations, etc. that are associated with the examples presented within the present disclosure may additionally and/or alternatively be included within the example method 200.

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing at least some of the claims.

Various operations of embodiments are provided herein. The order in which some or all of the operations described should not be construed to imply that these operations are necessarily order dependent. Alternative ordering will be appreciated having the benefit of this description. Further, it will be understood that not all operations are necessarily present in each embodiment provided herein. Also, it will be understood that not all operations are necessary in some embodiments.

Many modifications may be made to the instant disclosure without departing from the scope or spirit of the claimed subject matter. Unless specified otherwise, “first,” “second,” or the like are not intended to imply a temporal aspect, a spatial aspect, an ordering, etc. Rather, such terms are merely used as identifiers, names, etc. for features, elements, items, etc. For example, a first component and a second component correspond to component A and component B or two different or two identical components or the same component.

Moreover, “exemplary” is used herein to mean serving as an example, instance, illustration, etc., and not necessarily as advantageous. As used in this application, “or” is intended to mean an inclusive “or” rather than an exclusive “or.” In addition, “a” and “an” as used in this application are to be construed to mean “one or more” unless specified otherwise or clear from context to be directed to a singular form. Also, at least one of A and B or the like means A or B or both A and B. Furthermore, to the extent that “includes,” “having,” “has,” “with,” or variants thereof are used in either the detailed description or the claims, such terms are intended to be inclusive in a manner similar to “comprising”

Also, although the disclosure has been illustrated and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above-described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

1. A clamp for suspending a wire that extends between plural elevated locations, with the clamp for receiving the wire that extends to one of the plural elevated locations, the clamp comprising:
a base comprising a support surface that defines a first boundary of a wire receiving region that receives the extended wire and supports a portion of the wire upon the base at the one of the plural elevated locations;
a keeper comprising an elastomer lining that defines a second boundary of the wire receiving region; and
means for providing force to at least one of the keeper or the base such that, when the wire is in the receiving region, the elastomer lining:
is pressed against the wire to provide a static retaining force, as a function of the force, on the wire to retain the wire relative to the clamp, and
permits sliding of the wire relative to the clamp and along a direction of extent of the wire between the elevated locations when a pulling force on the wire exceeds the static retaining force and remains within a designed slip force range, with a lower limit of the designed slip force range being of lesser value than the static retaining force.

2. The clamp as set forth within claim 1, wherein the elastomer lining comprises at least one of ethylene propylene diene monomer rubber, fluoroelastomer, urethane, or silicone.

3. The clamp as set forth within claim 1, wherein the keeper comprises a body, and the elastomer lining abuts the body.

4. The clamp as set forth within claim 3, wherein at least one of the body or the elastomer lining comprises a structure to retain the elastomer lining relative to the body.

5. The clamp as set forth within claim 4, wherein the structure provides a retaining force that is greater than the pulling force such that the elastomer lining is retained relative to the body when the sliding of the wire relative to the clamp occurs.

6. The clamp as set forth within claim 5, wherein the structure comprises a first portion on the elastomer lining and a second portion on the body, and the first portion inter-fits with the second portion.

7. The clamp as set forth within claim 6, wherein the first portion comprises a protrusion from the elastomer lining.

8. The clamp as set forth within claim 7, wherein the second portion comprises a recess in the body.

9. The clamp as set forth within claim 1, wherein the base, the keeper and the means for providing force are configured such that an initial pulling force on the wire is required to begin the sliding of the wire and the pulling force on the wire within the range is required to maintain the sliding of the wire over a distance.

10. The clamp as set forth within claim 1, wherein the pulling force is in a direction along which the wire extends.

11. The clamp as set forth within claim 1, comprising a lubricant on the support surface of the base.

12. The clamp as set forth within claim 1, comprising a stiffener within the elastomer lining.

13.-20. (canceled)

21. The clamp as set forth within claim 1, wherein the means for providing force includes means for providing the static retaining force to be approximately 1000 lb of force pressing against the wire.

22. The clamp as set forth within claim 1, wherein the means for providing force includes means for permitting sliding of the wire with the lower limit of the designed slip force range being approximately 500 lb of force.

22. The clamp as set forth within claim 1, wherein the means for providing force includes means for permitting sliding of the wire with an upper limit of the designed slip force range being approximately 700 lb of force.

23. The clamp as set forth within claim 1, wherein the base and the keeper are sized to receive only a single wire.

24. The clamp as set forth within claim 1, wherein the base includes an inner support surface and two vertical side walls.

25. The clamp as set forth within claim 24, wherein each side wall is located at a respective lateral side of the base, with the wire being interposed between the two vertical side walls when located within the clamp.

26. The clamp as set forth within claim 24, wherein the keeper includes a body and a plurality of arms.

27. The clamp as set forth within claim 26, wherein the keeper includes a body 52 and a plurality of arms.

28. The clamp as set forth within claim 27, wherein each of the plurality of arms extend out, over the vertical side walls of the base.
